(19) United States
(12) Patent Application Publication
(10) Pub. No.: US 2010/0088156 A1
(43) Pub. Date: Apr. 8, 2010

(54) SYSTEM AND METHOD FOR SURVEYING MOBILE DEVICE USERS

(75) Inventor: Eric S. Wilson, Los Angeles, CA (US)

Correspondence Address: SNELL & WILMER LLP (OC), 600 ANTON BOULEVARD, SUITE 1400, COSTA MESA, CA, 92626, US

(73) Assignee: Sidebar, Inc., Santa Monica, CA (US)

(21) Appl. No.: 12/574,486

(22) Filed: Oct. 6, 2009

Related U.S. Application Data
(60) Provisional application No. 61/103,162, filed on Oct. 6, 2008.

(51) Int. Cl. G06Q 10/00; G06Q 50/00; G06F 15/16

(52) U.S. Cl. 705/10; 709/206

(57) ABSTRACT

A system and method for delivering surveys to mobile device users. Surveys are delivered to mobile device users based on the user's participation in a survey group. The surveys may be delivered with media such as a song, movie, television, or other video or audio clip asking the user to rate or provide feedback on the media. A method of providing a survey to communication devices includes receiving, at a server, a survey from a survey provider, defining, at the server, a survey group from a group of users, the survey group being defined by a topic in the survey, transmitting the survey from the server to a plurality of communication devices corresponding to the survey group, displaying the survey on each of the plurality of communication devices corresponding to the survey group, and transmitting survey responses from at least one of the plurality of communication devices to the server.

### CLAIM OF PRIORITY UNDER 35 U.S.C. §119

The present Application for Patent claims priority to Provisional Application No. 61/103,162 entitled “SYSTEM AND METHOD FOR SURVEYING MOBILE DEVICE USERS,” filed on Oct. 6, 2008, and assigned to the assignee hereof and hereby expressly incorporated by reference herein.

### BACKGROUND

1. Field

The invention relates generally to the field of content delivery (e.g., surveys, advertisements, media, promotions, etc.). More specifically, the invention relates to a system and method for surveying mobile device users.

2. Description of the Related Art

Improvements in communications technologies have led to an increase in the number of products/offerings provided by service providers (e.g., cable providers, internet providers, telephone companies, etc.), device manufacturers, content providers and companies offering and/or enabling value added services. Service providers offer numerous products which might include: voice services; data services such as text messaging and multimedia messaging; location based services; and internet access. Service providers also offer entertainment and a variety of content such as games, ring-tones and streaming music/video. As voice revenues diminish and service providers become increasingly reliant on customers' use of data services and consumption of content, these service providers are continuously searching for new revenue streams to augment the declining average revenue per user (ARPU).

Wireless devices have incorporated many improvements in wireless communication technologies. For example, traditional mobile phones now feature more memory, more processing capabilities and larger screens for the viewing of content. In order to maintain and/or increase market share and revenues, device manufacturers must integrate applications/features that increase ARPU for service providers. That is, service providers may choose to integrate applications/features that are a direct or indirect source of new revenues.

The communications industry has created stiff competition amongst service providers. That is, service providers must offer new content and access to content from third party providers in order to remain competitive in the marketplace. Furthermore, service providers must aggregate or develop content that matches the interests of their customers. Moreover, service providers must transform themselves into media companies and failure to do so may result in decreasing ARPU. The cost of providing increasingly sophisticated services and content may be offset if service providers increase ARPU. Hence, service providers must persuade their customers to use more of their products to remain viable.

Automation of business practices and procedures has led many organizations to implement a business model referred to as Customer Relationship Management (CRM). CRM enables organizations to effectively promote acquisition, retention and revenue optimization through the use of reliable systems, processes and procedures. CRM calls for the automation of basic business practices and the analysis of customer behavior and communication with customers through a variety of channels.

Service providers have long recognized the need to increase ARPU. One way to increase ARPU is through targeted, unobtrusive and engaging promotions and advertising. Content providers (e.g., advertisers, brands, marketers, promoters and media companies) have long recognized the mobile communications channel as being a pervasive and powerful way of connecting with their desired consumers (i.e., consumers they want to reach). Content providers have been searching for an effective model by which mobile communication devices may become a new medium to reach consumers. The invention addresses these needs as well as others by providing a system and method that advances the art.

### SUMMARY

The invention comprises a system and a method for consumer engagement and revenue optimization. The method provides for the display of surveys on a communication device as a result of a user's election to participate in a survey group. In an embodiment, the survey provider, such as a music or television producer, sends a sample video or music clip to the service provider. The service provider transmits the sample video or music clip along with a survey to all participants in a particular survey group. Users in the survey group provide feedback via inputting responses or comments into their communication device. This feedback is transmitted to the service provider, which in turn sends the survey results to the survey provider. The survey provider is then able to determine the public's response to a particular sample video or music clip, and can make business decisions based on the anticipated popularity of the movie, television show, or recorded song.

A system and method for delivering surveys to mobile device users is disclosed. Surveys are delivered to mobile device users based on the user's participation in a survey group. The surveys may be delivered with media such as a song, movie, television, or other video or audio clip asking the user to rate or provide feedback on the media. A method of providing a survey to communication devices includes receiving, at a server, a survey from a survey provider, defining, at the server, a survey group from a group of users, the survey group being defined by a topic in the survey, transmitting the survey from the server to a plurality of communication devices corresponding to the survey group, displaying the survey on each of the plurality of communication devices corresponding to the survey group, and transmitting survey responses from at least one of the plurality of communication devices to the server.

A further understanding of the nature and advantages of the invention herein may be realized by reference to the remaining portions of the specification and the attached drawings.

### BRIEF DESCRIPTION OF THE DRAWINGS

FIG. 1 is a block diagram of a system for providing surveys to communication or mobile devices in accordance with various embodiments of the invention;

FIG. 2 is a block diagram of a communication or mobile device in accordance with various embodiments of the invention; and

FIG. 3 is a flow diagram of a method for providing surveys to communication or mobile devices in accordance with various embodiments of the invention.

### DETAILED DESCRIPTION

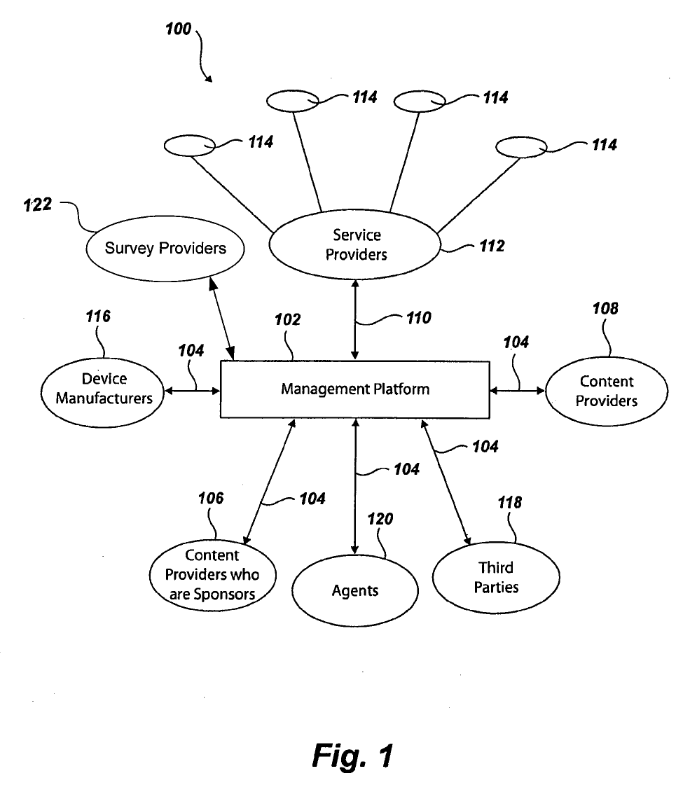

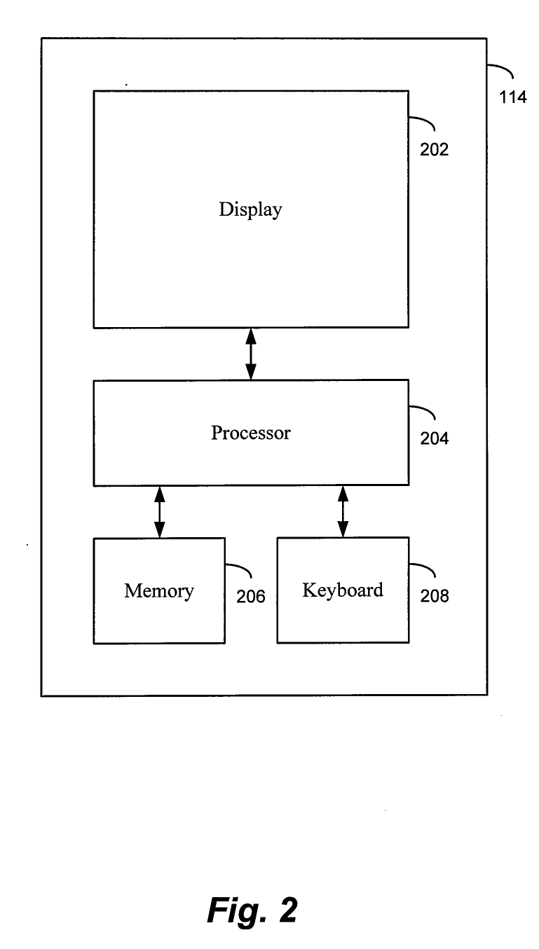

FIG. 1 is a block diagram of a system 100 for providing surveys to communication or mobile devices 114 in accordance with various embodiments of the invention. FIG. 2 is a block diagram of a communication or mobile device 114 in accordance with various embodiments of the invention. Referring to FIGS. 1 and 2, the system 100 includes a management platform 102, content providers 106 and 108, service providers 112, survey providers 122, and communication devices 114. The management platform 102, the content providers 106 and 108, the service providers 112, the survey providers 122 and the communication devices 114 may each have a processor 204, a memory 206, a display 202 and a keyboard 208. The processor 204 may be implemented using hardware, software, firmware, middleware, microcode, or any combination thereof. The processor 204 may be an Advanced RISC Machine (ARM), a controller, a digital signal processor (DSP), a microprocessor, an encoder, a decoder, circuitry, a processor chip, or any other device capable of processing data, and combinations thereof. The term “circuitry” may include processor circuitry, memory circuitry, RF transceiver circuitry, power circuitry, video circuitry, audio circuitry, keyboard circuitry, and display circuitry.

The memory 206 may include or store various routines and data. The term “memory” and “machine readable medium” include, but are not limited to, random access memory (RAM), flash memory, read-only memory (ROM), EPROM, EEPROM, registers, hard disk, removable disk, CD-ROM, DVD, wireless channels, and various other mediums capable of storing, containing or carrying instruction(s) and/or data. The machine readable instructions may be stored in the memory 206 and may be executed by the processor 204 to cause the processor 204 to perform various functions as described in this disclosure. The display 202 may be a LCD, LED or plasma display screen and the keyboard 208 may be a standard keyboard (e.g., a QWERTY layout) having letters and numbers.

The management platform 102 functions as the nerve center of the system 100. The management platform 102 connects through the internet 104 or other communication system with the content providers 108 and the content providers 106 who are sponsors. The management platform 102 also connects with the service providers 112 through, for example, a high bandwidth telephone line 110 (such as a T3 line), or other communication system (e.g., the internet). The content providers 108 and/or the service providers 112 may transmit data or content between the management platform 102 and the communication devices 114.

The internet 104 may provide the primary communications channel between the management platform 102, the content providers 108, the service providers 112, and the survey providers 122. However, telephone lines, power lines, cable, satellite and mail service may also be used. The high bandwidth telephone line 110 may provide the voice and/or data channel between the management platform 102 and the service providers 112. However, the internet 104 or a dedicated fiber, power line or satellite may be used. The management platform 102 may be co-located with the service providers 112 or embedded in the service providers' 112 computer systems; it may also be centralized with an ASP server or a third party 118. The service providers 112 may communicate with the communication devices 114 through a wireless network or via the internet. However, alternate embodiments may feature wired networks with wired communication devices 114. Survey providers 122 provide surveys and multimedia content to the management platform 102 for transmittal or transmission to the communication devices 114.

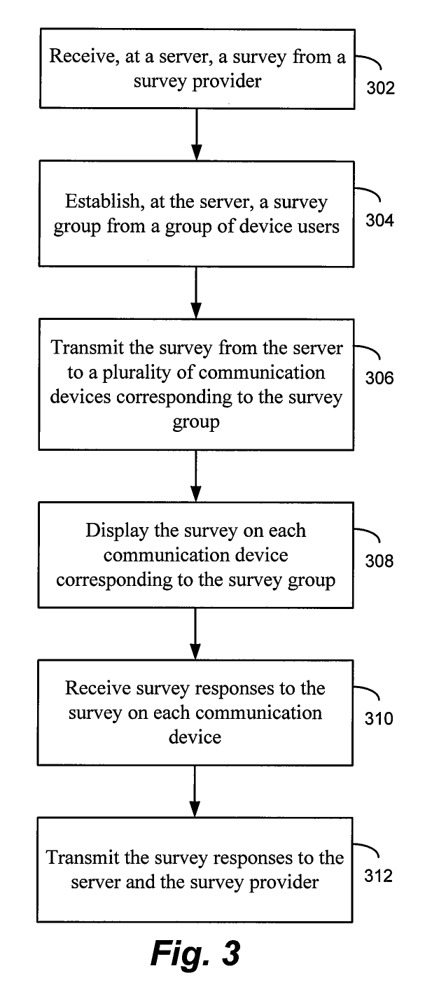

Referring to FIGS. 1-3, in step 302, the management platform 102 (e.g., a server) receives surveys from the survey providers 122. The survey providers 122 can include news agencies, product manufacturers and marketers, consumer products companies, and media related companies, for example, music, video, television, and movie producers. The survey providers 122 can be any person, organization, or institution that wishes to conduct surveys from a group of communication device users. In an embodiment, the service provider 112 can charge the survey provider 122 for distributing surveys to its customers or users based on the number of communication devices 114 the survey is transmitted to. In another embodiment, the service provider 112 may charge the survey provider 122 a flat fee for transmitting a survey to a specified group of communication devices 114. In yet another embodiment, the service provider 112 may charge the survey provider 122 a fee based on the number of customer responses received from a survey.

The management platform 102 can receive surveys from the survey providers 122 and transmit the surveys to customers or users of the communication devices 114 in real-time. The management platform 102 may receive surveys from various different survey providers 122. After the survey is received from the survey providers 122, the management platform 102 may transmit (e.g., via email, SMS text, MMS text, Web application, Internet link, etc.) the survey to a plurality of communication devices 114 (i.e., customers) based on pre-defined instructions, such as the number of customers to transmit the survey to or a defined group of customers falling into a particular category (e.g., males, ages 20-24, living in California). In another embodiment, the management platform 102 can store these surveys in its memory 206 and transmit these surveys to customers at a specified time or date or a later time or date. In yet another embodiment, the management platform 102 may transmit a survey to a first set of customers at a first time, and then transmit the survey to a second set of customers at a second time.

In step 304, each service provider 112 and/or the survey provider 122 may define or establish a survey group based on one or more factors. In an embodiment, a survey group is a group of customers who have opted to receive surveys relating to certain topics, such as, but not limited to, musical artists, political candidates, actors, movies, sports, music releases, clothes, automobiles, travel and/or consumer products. The list of topics provided in this application is not exhaustive and any topic which a person may have an opinion about can be included as a survey topic.

In an embodiment, a customer may subscribe or be invited to subscribe to various survey groups by communicating with the service provider 112 through their communication device 114. For example, a customer may send a text message requesting participating in a survey group, can call the service provider 112 or the survey provider 122 and verbally ask to be included in a survey group, or can navigate to an online location, such as the service provider's or survey provider's website, either through a computer or via their communication device's mobile browser, and select to be included in a survey group. In an embodiment, the service provider 112 or the survey provider 122 can periodically transmit a list of available survey groups to customers, by sending (e.g., via text message, email, etc.) the list to the communication devices 114, by mailing a notice through postal mail, or by listing the available survey groups at an online location. In an embodiment, when a customer registers for a new line of service for their communication device 114, the customer may elect to participate in one or more survey groups at that time.

In another embodiment, the size of the survey group can be restricted at the request of the survey provider 122. For example, if the survey provider 122 only wants to take a survey of 1000 customers, thus the survey group can be restricted to only the first 1000 customers who have elected to participate in the particular survey group. Furthermore, although a survey group may include, for example, 1000 customers, the survey provider may request that only 500 of the 1000 customers receive a particular survey. Thus, the survey provider 122 can control the number of customers in a survey group, as well as the number of customers within a survey group who actually receive a survey.

In yet another embodiment, a survey group can include a group of customers within a particular age, sex, demographic, geography, income level, ethnic group, political party, job category or description, etc. For example, various geographic survey groups are shown below in Table 1:

TABLE 1
Region

West
East
North West
South West
North East
South East
Mid West

The survey providers 122 may choose to send surveys to only users in, for example, the South East region survey group. In another embodiment, a survey group can include customers residing in particular countries, states, cities, or counties.

In step 306, the management platform 102 transmits the survey to the survey group (i.e., the communication devices corresponding to the survey group). As described above, the management platform 102 can transmit the survey to a particular survey group based on pre-defined parameters, such as number of customers to be included in the survey, time and day to transmit the survey, and staggering the delivery of surveys among various customers in the survey group.

In an embodiment, a survey can be transmitted to more than one survey group, or to certain customers from different survey groups. For example, if the survey provider 122 wishes to poll users interested in automobiles and clothes, then customers in an automobile survey group and customers in a clothing survey group would receive the particular survey. In this embodiment, a customer appearing in more than one group would only receive the survey once. The management platform 102 determines any duplicate customers between survey groups and filters out any duplicate names to prevent duplicate transmission of the survey.

In step 308, surveys are displayed on the communication devices 114 (i.e., on the display 202) of customers in the survey group. The survey may be in the form of an email or a text message, prompting the user to open and read the message, and then respond appropriately via text message back to the management platform 102. In another embodiment, the survey may be accompanied by a multimedia message, such as a music video, song, television show, movie, or an image of a product or design. The multimedia message may be in the form of a clip or trailer, or in the form of an entire length music video or song. The customer can view or listen to the multimedia message, and then respond to the associated survey.

In an embodiment, the customer may choose to save the survey in a repository or a memory 206 on the communication device 114 for later retrieval. A repository 206 may exist so that the customer can intentionally access the survey at the customer's leisure. Some surveys, however, might be available to a customer for a limited period of time or require a response within a specified period of time. The customer may open, view, input and respond to the survey (“survey responses”) using the keyboard 208 or communication device 114 (step 310).

In step 312, using the communication device 114, customers transmit their survey responses back to the management platform 102. In an embodiment, the survey response can be an indication of their preference of the media, for example, “1” indicating that the customer enjoyed the media, “2” indicating that the customer did not enjoy the media, or “3” indicating that the customer does not have a preference regarding the media.

In another embodiment, the customer response can be more detailed. For example, the customer can provide more specificity as to what aspects of the media they enjoy or dislike, or provide suggestions or feedback regarding the media. For example, the survey may ask customers specific questions, such as “Did you enjoy listening to the music clip?”, “Would you go to the theater to watch this movie?”, and “How do you like how this car looks?” and allow the user to provide detailed response to these questions. The survey can be customized per the survey providers 122 needs, and can include questions, information, and media for the customer.

As described above, the customer transmits their response by interacting with their communication device 114. The customer can reply to a text or multimedia message survey with a text message. In another embodiment, the customer may be prompted to call a phone number and provide a verbal response to the survey. In another embodiment, the customer may be directed to an online location on a mobile browser on their communication device 114 where responses to the survey can be entered.

In step 312, the management platform 102 transmits the survey responses to the corresponding survey provider 122. In an embodiment, the management platform 102 can store survey responses until all responses are received. At that time, the management platform 102 transmits all of the survey responses to the survey provider 122. In this embodiment, if only one-half of the customers responded to a survey, the management platform 102 can wait for a period of time, and then transmit all received survey responses to the survey provider 122. This delay ensures that ample time is provided to all customers who wish to respond to the survey, but also provides for a timely delivery of survey results to the survey provider 122. The period of time can be set by the survey provider 122 or the management platform 102. Furthermore, the management platform 102 can provide data to the survey provider 122 such as the number of customers and information about the customers (e.g., age, sex, etc.) who failed to respond to the survey.

Alternatively, the management platform 102 can transmit survey responses to the survey provider 122 in real-time upon receipt of survey responses from customers. This embodiment allows the survey providers 122 to receive survey responses in a timely fashion as the responses are provided.

In another embodiment, the customer or communication device 114 can transmit survey responses directly back to the survey provider 122, bypassing transmission of the survey responses to the management platform 102.

In another embodiment, instead of receiving a text or multimedia associated with a survey on their communication device 114, customers can receive a phone call from a survey provider 122. The phone call can play a recorded survey to the customer, who can then respond by pressing keys (e.g., the keyboard 208) on their communication device 114, or by verbally answering the survey questions. In another embodiment, the phone call can play a recorded music clip, followed by a recorded survey.

Those skilled in the art will appreciate that the various illustrative logical blocks, modules, circuits, and algorithms described in connection with the embodiments disclosed herein may be implemented as electronic hardware, computer software, or combinations of both. To illustrate this interchangeability of hardware and software, various illustrative components, blocks, modules, circuits, and algorithms have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processing device, a digital signal processing device (DSP), an application specific integrated circuit (ASIC), a field programmable gate array (FPGA) or other programmable logic device, discrete gate or transistor logic, discrete hardware components, or any combination thereof designed to perform the functions described herein. A general purpose processing device may be a microprocessing device, but in the alternative, the processing device may be any conventional processing device, processing device, microprocessing device, or state machine. A processing device may also be implemented as a combination of computing devices, e.g., a combination of a DSP and a microprocessing device, a plurality of microprocessing devices, one or more microprocessing devices in conjunction with a DSP core or any other such configuration.

The apparatus, methods or algorithms described in connection with the embodiments disclosed herein may be embodied directly in hardware, software, or combination thereof. In software the methods or algorithms may be embodied in one or more instructions that may be executed by a processing device. The instructions may reside in RAM memory, flash memory, ROM memory, EPROM memory, EEPROM memory, registers, hard disk, a removable disk, a CD-ROM, or any other form of storage medium known in the art. An exemplary storage medium is coupled to the processing device such the processing device can read information from, and write information to, the storage medium. In the alternative, the storage medium may be integral to the processing device. The processing device and the storage medium may reside in an ASIC. The ASIC may reside in a user terminal. In the alternative, the processing device and the storage medium may reside as discrete components in a user terminal.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

The invention may be embodied in other specific forms without departing from its spirit or essential characteristics. The described embodiments are to be considered in all respects only as illustrative and not restrictive and the scope of the invention is, therefore, indicated by the appended claims rather than by the foregoing description. All changes which come within the meaning and range of equivalency of the claims are to be embraced within their scope.

What is claimed is:

1. A method of providing a survey to communication devices comprising:
receiving, at a server, a survey from a survey provider;
defining, at the server, a survey group from a group of users;
transmitting the survey from the server to a plurality of communication devices corresponding to the survey group;
displaying the survey on each of the plurality of communication devices corresponding to the survey group; and
transmitting survey responses from at least one of the plurality of communication devices to the server.

2. The method of claim 1 wherein the survey responses are input by a user of each of the plurality of communication devices.

3. The method of claim 1 wherein the survey includes multimedia content.

4. The method of claim 1 wherein each of the plurality of communication devices access the survey using a Web browser or an Internet link.

5. The method of claim 1 wherein the survey group is defined by a topic in the survey.

6. The method of claim 5 wherein the topic is selected from a group consisting of a musical artist, a political candidate, an actor, a movie, a sport, a brand of clothing, an automobile, a consumer product, and combinations thereof.

7. The method of claim 1 further comprising receiving, at the server, a request from at least one of the plurality of communication devices to be included in the survey group.

8. The method of claim 1 further comprising transmitting a list of available survey groups from the server to each of the plurality of communication devices.

9. The method of claim 1 wherein the survey group includes a group of users within a particular age, sex, demographic, geography, income level, ethnic group, political party, or job category or description.

10. The method of claim 1 wherein each of the plurality of communication devices store the survey in a memory for retrieval at a later time or date.

11. A system for providing a survey to communication devices comprising:
a management platform for receiving a survey from a survey provider and defining a survey group from a group of users; and
a plurality of communication devices corresponding to the survey group for receiving the survey from the management platform, displaying the survey, inputting survey responses, and transmitting the survey responses to the management platform.

12. The system of claim 11 wherein the survey responses are input by a user of each of the plurality of communication devices.

13. The system of claim 11 wherein the survey includes multimedia content.

14. The system of claim 11 wherein each of the plurality of communication devices access the survey using a Web browser or an Internet link.

15. The system of claim 11 wherein the survey group is defined by a topic in the survey.

16. The system of claim 15 wherein the topic is selected from a group consisting of a musical artist, a political candidate, an actor, a movie, a sport, a brand of clothing, an automobile, a consumer product, and combinations thereof.

17. The system of claim 11 further comprising receiving, at the server, a request from at least one of the plurality of communication devices to be included in the survey group.

18. The system of claim 11 further comprising transmitting a list of available survey groups from the server to each of the plurality of communication devices.

19. The system of claim 11 wherein the survey group includes a group of users within a particular age, sex, demographic, geography, income level, ethnic group, political party, or job category or description.

20. The system of claim 11 wherein each of the plurality of communication devices store the survey in a memory for retrieval at a later time or date.
